(19) United States
(12) Patent Application Publication
(10) Pub. No.: US 2012/0070559 A1
(43) Pub. Date: Mar. 22, 2012

(54) Milled Cassava Product

(75) Inventor: Carter Foss, Brentwood, TN (US)

(73) Assignee: AMERICAN KEY FOOD PRODUCTS, Closter, NJ (US)

(21) Appl. No.: 12/886,174

(22) Filed: Sep. 20, 2010

(51) Int. Cl. A23L 1/214; A21D 13/08; A23P 1/00; A21D 13/04

(52) U.S. Cl. 426/550; 426/615; 426/481

(57) ABSTRACT

The present invention relates to a milled cassava product comprising a certain size distribution of milled cassava particle that is especially useful as a substitute for wheat or other gluten-containing flours. The present invention also relates to methods for producing the milled cassava product. Further, the present invention relates to foodstuffs comprising the milled cassava product, especially those that have reduced gluten or are gluten-free.

### CROSS REFERENCE TO RELATED APPLICATIONS

Not Applicable.

### STATEMENT REGARDING FEDERALLY SPONSORED RESEARCH OR DEVELOPMENT

Not Applicable.

### BACKGROUND

Cassava is grown in tropical countries around the world. World trade in cassava is mostly in the form of pellets and chips for feed, and starch and flour for food processing and industrial use. Fresh cassava root is not widely traded given the product's bulkiness and perishable nature. In Brazil, cassava is traditionally ground into “farinha,” which translates in English to “flour.” This flour, however, is coarser than wheat flour and would generally be considered a “meal” by American standards. Although some producers in Brazil produce a finer product, the product is still coarser than wheat flour used in American and European baking. Starch from the cassava root can also be extracted to produce cassava starch, also known as tapioca starch or tapioca flour. This starch, which lacks protein and fiber, is also not equivalent to wheat flour.

Wheat flour is traditionally a staple ingredient of baked goods. Goods made from wheat flour, however, are not preferred by or suitable to all consumers because wheat flour contains gluten. Gluten is the term commonly used to describe certain proteins found in wheat (including durum, semolina, and spelt), rye, barley, related grain hybrids such as triticale and kamut, and possibly oats. Many consumers wish to decrease the amount of gluten in their diets. Thus there is a growing demand for gluten-free foods and substitutes for wheat flour or other gluten-containing flours for use in a variety of foodstuffs.

Celiac Disease (CD) is a disorder afflicting approximately one out of 133 people in the United States (Fasano A., et al. (2003) Archives of Internal Medicine; 163(3):268-92). Celiac disease is a chronic inflammatory disorder of the small intestine in genetically susceptible individuals that is triggered by ingesting gluten. Although there is currently no cure for CD, its symptoms may be reduced by avoiding sources of gluten in the diet. Gluten-Free Labeling of Foods, 72 Fed. Reg. 2795 (Jan. 23, 2007).

Gluten exhibits cohesive, elastic, and viscous properties vital to formation of the familiar texture of many products containing wheat flour, especially baked goods such as pastries, cakes, breads, etc. Reproducing these textures is difficult in the absence of wheat or other gluten-containing flour. Some alternatives approaches to using gluten-containing flour include the use of eggs, starches, dairy products, gums and hydrocolloids, and other non-gluten proteins. It is also common to use a combination of wheat flour substitutes, such as rice starch, potato starch, almond flour, maize flour, buckwheat flour, and soy flour, to mimic the attributes provided by gluten. (U.S. Pat. No. 12/094,773). It would be advantageous to provide a flour substitute that could simplify recipes by reducing the number of gluten-free flour substitutes and other ingredients needed to provide the desired texture, mouth-feel, and taste that consumers are accustom to.

### SUMMARY OF THE INVENTION

Certain embodiments of the present invention are drawn to milled cassava products comprising particles of milled cassava with a particle size distribution determined by OCS Test 2839 (4^{th} edition) where less than about 1% of the particles are held on a #40(US) sieve when the size distribution is determined with a #40(US) sieve and from about 40% to about 65% of the particles are held on a #80(US) sieve when the size distribution is determined with a #40(US) sieve and a #80(US) sieve. Further, certain embodiments are drawn to foodstuffs comprising such milled cassava products. In certain embodiments, the foodstuffs may have reduced gluten or be gluten free.

Certain embodiments of the present invention are drawn to methods of producing a milled cassava product where cassava is milled into particles, the milled particles are separated by size; and the size separated milled particles are blended together in proportions to produce a milled cassava product as described herein. In certain embodiments, methods of producing a milled cassava product involve milling cassava into particles using processing equipment optimized to produce a milled product with a particle size distribution consistent with the milled cassava products described herein.

### DETAILED DESCRIPTION

I. Definitions

The screen or sieve numbers referred to herein are U.S.A. sieve series equivalents as conventionally used by those of skill in the art unless otherwise indicated (also referred to herein as US number, US#, or # (US)). Table 1 is a conversion chart indicating sizes corresponding to U.S.A. sieve series numbers (“Testing Sieves and Their Uses, Handbook 53, 1982 Edition,” Tyler Combustion Engineering, Inc.). One of skill in the art will recognize that the present invention is not limited to the use of screens or sieves designated by US number, but are applicable to any screens or sieves of corresponding opening size.

TABLE 1
Particle Size Conversion Chart.

| | | Tyler Screen Scale |
|---|---|---|
| Sieve | Nominal Sieve | Equivalent |
| Designation | Opening | Designation |

| Standard | US # | inches | mm | mesh |
|---|---|---|---|---|
| 0.500 mm | #35 | 0.0197 | 0.500 | 32 mesh |
| 0.425 mm | #40 | 0.0165 | 0.425 | 35 mesh |
| 0.250 mm | #60 | 0.0098 | 0.250 | 60 mesh |
| 0.180 mm | #80 | 0.0070 | 0.180 | 80 mesh |
| 0.150 mm | #100 | 0.0059 | 0.150 | 100 mesh |
| 0.125 mm | #120 | 0.0049 | 0.125 | 115 mesh |
| 0.106 mm | #140 | 0.0041 | 0.106 | 150 mesh |
| 0.075 mm | #200 | 0.0029 | 0.075 | 200 mesh |
| 0.038 mm | #400 | 0.0015 | 0.038 | 400 mesh |

The FDA has proposed a definition of the term “gluten-free” for voluntary use in the labeling of food. 72 Fed. Reg. 2795 (Jan. 23, 2007). According to this definition, gluten-free means that a food does not contain any of the following: (i) an ingredient that is any species of the grains wheat, rye, barley, or a crossbred hybrid of these grains (all noted grains are collectively referred to as “prohibited grains”); (ii) an ingredient that is derived from a prohibited grain and that has not been processed to remove gluten (e.g., wheat flour); (iii) an ingredient that is derived from a prohibited grain and that has been processed to remove gluten (e.g., wheat starch), if the use of that ingredient results in the presence of 20 parts per million (ppm) or more gluten in the food; or (iv) 20 ppm or more gluten.

As used herein, the term “gluten-free” is consistent with the FDA's proposed definition.

As used herein, the phrase “reduced gluten” or the like refers to a food ingredient or foodstuff that contains less gluten than would be present if the food ingredient or foodstuff were prepared with the standard amount of “prohibited grain” as defined herein for “gluten-free.”

II. Overview

In many tropical areas of the world, cassava is processed into products that have traditionally been known in the United States as cassava flour, tapioca flour, and tapioca starch. While the term “flour” has been applied, this product is not the same in particle size as conventional wheat flour used in American and European baking. In general, this product is more coarse and meal-like. Alternatively, “starch” extracted from the cassava root is very fine and lacks protein and fiber. Neither of these products is well suited as a significant substitute for wheat or other gluten-containing flours in foodstuffs. The milled cassava product of the present invention is neither a traditional cassava flour nor a cassava or tapioca starch. The milled cassava product of the invention differs from cassava flour in its distribution of particle sizes. The milled cassava product of the invention differs from cassava starch both because of its particle size distribution and because it retains fiber and protein absent from:isolated starch.

The present invention provides certain compositions of a milled cassava product useful in food applications, methods of making the milled cassava product, and various applications of the product. In particular, the milled cassava product may be used as a substitute for wheat flour or other gluten-containing flours in foodstuffs, such as baked goods. Because cassava does not contain gluten, foodstuffs made with the milled cassava product can have reduced gluten or be gluten-free. Although the properties of the milled cassava product of the present invention are particularly suited for use in baking, one of skill in the art will recognize that it can be used in a variety of other foodstuffs just as the use of wheat flour is not just limited to baking.

III. Cassava Processing

Cassava processing generally comprises the steps of receiving the cassava roots, pre-washing them, peeling and washing them, grinding/grating/chipping them, pressing the ground material to remove water, dissociating the pressed material, drying the material, milling the dried material, and screening/classifying the material by size. One of skill in the art will recognize that modification of this general production scheme are possible and can be implemented to suit specific applications. For example, when the product desired is starch, the water removed from the pressing step is collected and evaporated to obtain fine starch and the by-product solid material can be used for animal feed.

There are a number of types and sources of cassava roots such as, but not limited to, the cassava species M. esculenta Crantz, from which most commercial varieties of cassava are derived. The preferred type and/or source of cassava roots to be processed varies depending on the intended application. The age of the cassava root is also a consideration. For example, older roots develop fibrous veins of lignin that may impart an undesirable hardness, to a milled product, but older roots have a higher starch content that is desirable for starch extraction. When producing a milled cassava product of the present invention, cassava roots are preferably processed within a 36 hour window after harvesting. As there is not a mature stage for cassava, cassava roots are ready for harvesting as soon as the storage roots of the plants are large enough to meet the requirements of the consumers. Typically, harvesting can begin as soon as eight months after planting. In the tropics, however, plants may remain unharvested for more than one growing season, thus allowing the storage roots to enlarge further. As noted though, as the roots age, the central portion becomes woody and eventually inedible.

Because the cassava roots are pulled from the ground, it is preferable that they be pre-cleaned to remove dirt and debris before processing.

The cassava roots are peeled before they are ground. Peeling may be done by hand, but mechanical peeling is preferred for large scale processing applications. Various mechanical peelers known to those of skill in the art are available for such purposes. After peeling, the peeled roots are washed. This washing step is particularly effective at reducing microbial contamination.

The peeled and washed roots may be inspected, such as visually inspected and/or by running the roots near a magnet, to remove debris, such as inedible material and any metal that could damage downstream processing equipment.

The peeled and washed roots are ground to break them up. This step is also referred to as grating or chipping. Where the final product is a meal, or flour, or other milled product not coming from the evaporation of starch containing water, the particle size of the final product is in part determined by the size of the particles resulting in this first grinding step. One of skill in the art will recognize that the size of cassava particles following this step are affected by the setting and operation of the particular equipment used, but that it is within the skill of one of skill in the art to adjust the operation of such equipment to adjust the particle size of the material produced such that, in conjunction with downstream steps, the desired final size and distribution of particles is achieved.

The ground cassava is then pressed to remove water. Generally, a significant amount of water is pressed out of the ground material to help facilitate drying.

Pressing of the ground cassava material turns it into a pressed cake. This pressed cake is broken-up or disintegrated by agitation, such as transport by conveyor screw, before the material is dried. The loose particles may optionally be screened to remove large pieces of fiber that are unsuitable as such for human consumption, with the material passing through the screen continuing to the drying step.

Drying of the particles may be achieved by a number of methods such as by drying in the sun or mechanical drying. In a continuous mechanized process, for example, the cassava particles can be spread onto a heated, rotating table where they are dried to the desired moisture content. In certain embodiments of the present invention, the maximum moisture content is 8%. This drying process is variable by geographical region/processing plant/individual production runs, and results in different degrees of drying, also referred to as toasting. The more toasted the cassava material, the harder it becomes, resulting in fewer fine particles when milled. This results in a coarser milled product. Coarser particles can impart a crunchy, or gritty, or sanding texture to foodstuffs, such as baked goods, that is generally undesirable when replacing wheat flour in a recipe. One of skill in the art will recognize that the combination of grinding steps and toasting affects the final particle size and size distribution. One of skill in the art will recognize that it is within the skill of the art to vary these parameters according to the equipment used to achieve a desired particle size and distribution. In certain embodiments, the cassava product is less toasted to allow for its milling into a larger proportion of finer particles and to reduce the amount of large particles.

The heat applied during the drying of the cassava material also affects the amount of gelatinization of the starch. Starch gelatinization occurs when starch is heated in the presence of water which causes the starch to undergo a transition process, during which the granules break down into a mixture of polymers-in-solution. In general, the more intense the heating, the more gelatinization occurs. It has been observed that the amount of gelatinization can impact the properties of the final milled cassava product and make it more or less suitable for certain cooking applications. In certain embodiments, the amount of gelatinization of the milled cassava product does not exceed about 50% gelatinization. In certain embodiments, the amount of gelatinization of the milled cassava product does not exceed about 45% gelatinization. In certain embodiments, the amount of gelatinization of the milled cassava product is from about 30% to about 50% gelatinization. In certain embodiments, the amount of gelatinization of the milled cassava product is from about 35% to about 50% gelatinization. In certain embodiments, the amount of gelatinization of the milled cassava product is from about 35% to about 45% gelatinization. In certain embodiments, the amount of gelatinization of the milled cassava product is from about 30% to about 40% gelatinization. In certain embodiments, the amount of gelatinization of the milled cassava product is from about 35% to about 40% gelatinization. In certain embodiments, the amount of gelatinization of the milled cassava product is from about 40% to about 45% gelatinization.

Following drying, the dried particles are milled to their final particle sizes. This can be done, for example, by a hammer mill, disc attrition mill, or various other milling apparatuses known to those of skill in the art.

The milled cassava product can then be classified/sorted by size. This is generally accomplished by passing the product through screens or sieves to achieve products of the desired size. Traditionally, this is done only to exclude large particles and/or fiber residue without regard to particle size distribution.

The final product can be inspected, such as by a magnet or metal detector, and packaged for distribution.

In order to produce a milled cassava product suitable as a wheat or gluten-containing flour substitute, methods of producing currently known cassava flours required improvement. For example, in the Sao Paulo, Brazil, market, cassava flour is consumed as “farinha grossa” or “course flour” that has an average particle size above 2 mm. In other parts of Brazil, “farinha fina” or fine flour that has a maximum 10% of the flour particle size above 2 mm is preferred. Even this flour is too coarse and unsuitable for use as a wheat or gluten-containing flour substitute. Therefore, the milled cassava product of the present invention must be finer. However, the product cannot be too fine. Thus simply milling all the particles to a very small size is unsuitable. When a certain proportion of particles in a milled cassava product is too fine, the product will not perform satisfactorily because, among other things, it absorbs too much water.

Instead, it was discovered that a achieving a certain distribution of both relatively larger and smaller particles sizes is required. One method of achieving a certain size distribution is to separate or fraction the milled cassava particles by size. These fractions may then be blended together to achieve a desired distribution of particle sizes. For example, blending a certain percentage of particles that pass through a #40(US) sieve but are retained on a #60(US) sieve with a certain percentage of particles that pass through a #60(US) sieve but are retained on a #80(US) sieve with a certain percentage of particles that pass through a #80(US) sieve but are retained on a #100(US) sieve, etc. This method allows for milled cassava products with very precise amounts of different particle sizes to be produced. Separating and blending of milled cassava particles, however, complicates production of a product. Alternatively, a milled cassava product of acceptable size distribution can be produced by optimizing the processing parameters of how the cassava roots are initially ground, the extent to which the ground material is dried, and how the dried material is subsequently milled. These parameters will be set according to the particular combination of processing equipment used. In general, this may be achieved through milling the product finer than has been traditionally done, but not too fine, and then screening out particles of certain sizes. In certain embodiments, the material is initially passed through a #40(US) sieve.

IV. Size Distribution

It was determined that cassava flour, such as obtained from cassava flour manufacturers in Brazil, was undesirable and in certain cases unsuitable as wheat or other gluten-containing flour substitutes or for use otherwise in bakery products. More particularly, it was determined that large particles-such as particles held on a #35(US) or #40(US) sieve-negatively affected the texture, resulting in course or grainy products. It was discovered, however, that simply removing the larger particles did not result in milled cassava product suitable in baking either. Instead, it was discovered that the size distribution of compositions comprising finer cassava particles was important to producing a suitable product. In fact, wherein the inclusion of large particles resulted in baked goods that were to coarse and crumbly, too large a percentage of very fine particles absorbed too much water and failed to produce suitable baked goods.

Prior specifications of cassava flour have only specified excluding particles of larger sizes. For example, the Tapioca Institute of America (October 1943) graded cassava flours according to United States standard sieves, #140, #80, and #60. The method employed was fifty grams of flour screened through the appropriate sieve according to the desired grade. It was noted that while more accurate result could be obtained by making the test with a Ro-tap machine or other type of mechanical shaker, satisfactory results could be obtained by hand shaking. Table 2 show the grade classifications as specified by the Tapioca Institute of America, October 1943.

TABLE 2

| | Percent required | Mesh sieve |
|---|---|---|
| Grade | to pass | to be passed |
| A | 99% | #140(US) |
| B | 99% | #80(US) |
| C | 95% | #60(US) |

As used herein unless otherwise specified, the size distribution of the cassava particles is measured as determined by OCS Test 2839 (4^{th} edition), i.e., 100 g of sample on Ro-tap machine for 5 minutes, with the screens specified. One of skill in the art will recognize that approximate results may be achieved with similar protocols. However, in particular, it was observed that because the ground cassava particles are not necessarily spherical, but in some cases elongated or fibrous, prolonged shaking on the screen allows a larger percentage of these particles to pass through because the increased time allowed them more of an opportunity to work themselves into an orientation that fit through the screen.

The present invention relates to a milled cassava product comprising a suitable size distribution of cassava particles for use especially in baking. In certain embodiments, the milled cassava product has a size distribution wherein less than about 5% of the milled cassava particles are held on a #40(US) sieve. In certain embodiments, the milled cassava product has a size distribution wherein less than about 4% of the milled cassava particles are held on a #40(US) sieve. In certain embodiments, the milled cassava product has a size distribution wherein less than about 3% of the milled cassava particles are held on a #40(US) sieve. In certain embodiments, the milled cassava product has a size distribution wherein less than about 2% of the milled cassava particles are held on a #40(US) sieve. In certain embodiments, the milled cassava product has a size distribution wherein less than about 1% of the milled cassava particles are held on a #40(US) sieve. In certain embodiments, the milled cassava product has a size distribution wherein less than about 0.5% of the milled cassava particles are held on a #40(US) sieve. In certain embodiments, the milled cassava product has a size distribution wherein less than about 0.1% of the milled cassava particles are held on a #40(US) sieve.

It is not desirable that too large a percentage of the milled cassava particles be too fine when the milled cassava product has a size distribution wherein less than about 5%, or less than about 4%, or less than about 3%, or less than about 2%, or less than about 1%, or less than about 0.5%, or less than about 0.1% of the milled cassava particles are held on a #40(US) sieve. The distribution of larger versus finer particles may be determined with a #40(US) sieve and a #80(US) sieve. In certain embodiments, from about 40% to about 65% of the cassava particles are held on a #80(US) sieve. In certain embodiments, from about 45% to about 65% of the cassava particles are held on a #80(US) sieve. In certain embodiments, from about 50% to about 65% of the cassava particles are held on a #80(US) sieve. In certain embodiments, from about 55% to about 65% of the cassava particles are held on a #80(US) sieve. In certain embodiments, from about 60% to about 65% of the cassava particles are held on a #80(US) sieve. In certain embodiments, from about 40% to about 60% of the cassava particles are held. on a #80(US) sieve. In certain embodiments, from about 40% to about 55% of the cassava particles are held on a #80(US) sieve. In certain embodiments, from about 40% to about 50% of the cassava particles are held on a #80(US) sieve. In certain embodiments, from about 40% to about 45% of the cassava particles are held on a #80(US) sieve. In certain embodiments, from about 45% to about 60% of the cassava particles are held on a #80(US) sieve. In certain embodiments, from about 45% to about 55% of the cassava particles are held on a #80(US) sieve. In certain embodiments, from about 45% to about 50% of the cassava particles are held on a #80(US) sieve. In certain embodiments, from about 50% to about 60% of the cassava particles are held on a #80(US) sieve. In certain embodiments, from about 50% to about 55% of the cassava particles are held on a #80(US) sieve. In certain embodiments, from about 55% to about 60% of the cassava particles are held on a #80(US) sieve.

Size distribution may also be determined with a #40(US) sieve, a #60(US) sieve, and a #80(US) sieve. In certain embodiments, from about 20% to about 40% of the cassava particles are held on a #60(US) sieve. In certain embodiments, from about 25% to about 40% of the cassava particles are held on a #60(US) sieve. In certain embodiments, from about 30% to about 40% of the cassava particles are held on a #60(US) sieve. In certain embodiments, from about 35% to about 40% of the cassava particles are held on a #60(US) sieve. In certain embodiments, from about 20% to about 35% of the cassava particles are held on a #60(US) sieve. In certain embodiments, from about 20% to about 30% of the cassava particles are held on a #60(US) sieve. In certain embodiments, from about 20% to about 25% of the cassava particles are held on a #60(US) sieve. In certain embodiments, from about 25% to about 35% of the cassava particles are held on a #60(US) sieve. In certain embodiments, from about 25% to about 30% of the cassava particles are held on a #60(US) sieve. In certain embodiments, from about 30% to about 35% of the cassava particles are held on a #60(US) sieve.

It is understood that when the size distribution of a milled cassava product is done with a #40(US) sieve and both a #60(US) and #80(US) sieve, the percentage of cassava particles held on the #60(US) sieve and the #80(US) sieve added together will equal the percentage of cassava particles held on a #80(US) sieve in the absence of the #60(US) sieve. In certain embodiments wherein the size distribution is determined using a #40(US) sieve, a #60(US) sieve, and a #80(US) sieve, the ratio of cassava particles held on the #60(US) sieve to cassava particles held on the #80(US) sieve is about 2 to 1, or is about 1.9 to 1, or is about 1.8 to 1, or is about 1.7 to 1, or is about 1.6 to 1, or is about 1.5 to 1, or is about 1.4 to 1, or is about 1.3 to 1, or is about 1.2 to 1, or is about 1.1 to 1, or is about 1 to 1, or is about 0.9 to 1, or is about 0.8 to 1, or is about 0.7 to 1, or is about 0.6 to 1, or is about 0.5 to 1.

Size distribution may also be determined with a #40(US) sieve, a #60(US) sieve, a #80(US) sieve, and a #100(US) sieve. In certain embodiments, less than about 10% of the cassava particles are held on a #100(US) sieve. In certain embodiments, from about 1% to about 10% of the cassava particles are held on a #100(US) sieve. In certain embodiments, from about 2% to about 10% of the cassava particles are held on a #100(US) sieve. In certain embodiments, from about 3% to about 10% of the cassava particles are held on a #100(US) sieve. In certain embodiments, from about 4% to about 10% of the cassava particles are held on a #100(US) sieve. In certain embodiments, from about 5% to about 10% of the cassava particles are held on a #100(US) sieve. In certain embodiments, from about 6% to about 10% of the cassava particles are held on a #100(US) sieve. In certain embodiments, from about 1% to about 9% of the cassava particles are held on a #100(US) sieve. In certain embodiments, from about 1% to about 8% of the cassava particles are held on a #100(US) sieve. In certain embodiments, from about 1% to about 7% of the cassava particles are held on a #100(US) sieve. In certain embodiments, from about 1% to about 6% of the cassava particles are held on a #100(US) sieve. In certain embodiments, from about 1% to about 5% of the cassava particles are held on a #100(US) sieve. In certain embodiments, from about 1% to about 4% of the cassava particles are held on a #100(US) sieve. In certain embodiments, from about 1% to about 3% of the cassava particles are held on a #100(US) sieve. In certain embodiments, from about 2% to about 9% of the cassava particles are held on a #100(US) sieve. In certain embodiments, from about 2% to about 8% of the cassava particles are held on a #100(US) sieve. In certain embodiments, from about 2% to about 7% of the cassava particles are held on a #100(US) sieve. In certain embodiments, from about 2% to about 6% of the cassava particles are held on a #100(US) sieve. In certain embodiments, from about 2% to about 5% of the cassava particles are held on a #100(US) sieve. In certain embodiments, from about 2% to about 4% of the cassava particles are held on a #100(US) sieve. In certain embodiments, from about 2% to about 3% of the cassava particles are held on a #100(US) sieve. In certain embodiments, from about 3% to about 9% of the cassava particles are held on a #100(US) sieve. In certain embodiments, from about 3% to about 8% of the cassava particles are held on a #100(US) sieve. In certain embodiments, from about 3% to about 7% of the cassava particles are held on a #100(US) sieve. In certain embodiments, from about 3% to about 6% of the cassava particles are held on a #100(US) sieve. In certain embodiments, from about 3% to about 5% of the cassava particles are held on a #100(US) sieve. In certain embodiments, from about 3% to about 4% of the cassava particles are held on a #100(US) sieve. In certain embodiments, from about 4% to about 9% of the cassava particles are held on a #100(US) sieve. In certain embodiments, from about 4% to about 8% of the cassava particles are held on a #100(US) sieve. In certain embodiments, from about 4% to about 7% of the cassava particles are held on a #100(US) sieve. In certain embodiments, from about 4% to about 6% of the cassava particles are held on a #100(US) sieve. In certain embodiments, from about 4% to about 5% of the cassava particles are held on a #100(US) sieve. In certain embodiments, from about 5% to about 9% of the cassava particles are held on a #100(US) sieve. In certain embodiments, from about 5% to about 8% of the cassava particles are held on a #100(US) sieve. In certain embodiments, from about 5% to about 7% of the cassava particles are held on a #100(US) sieve. In certain embodiments, from about 5% to about 6% of the cassava particles are held on a #100(US) sieve. In certain embodiments, from about 6% to about 9% of the cassava particles are held on a #100(US) sieve. In certain embodiments, from about 6% to about 8% of the cassava particles are held on a #100(US) sieve. In certain embodiments, from about 6% to about 7% of the cassava particles are held on a #100(US) sieve. In certain embodiments, from about 7% to about 9% of the cassava particles are held on a #100(US) sieve. In certain embodiments, from about 7% to about 8% of the cassava particles are held on a #100(US) sieve. In certain embodiments, from about 8% to about 9% of the cassava particles are held on a #100(US) sieve.

Size distribution may also be determined with a #40(US) sieve, a #60(US) sieve, a #80(US) sieve, a #100(US) sieve, and a #120(US) sieve. In certain embodiments, less than about 10% of the cassava particles are held on a #120(US) sieve. In certain embodiments, from about 1% to about 10% of the cassava particles are held on a #120(US) sieve. In certain embodiments, from about 2% to about 10% of the cassava particles are held on a #120(US) sieve. In certain embodiments, from about 3% to about 10% of the cassava particles are held on a #120(US) sieve. In certain embodiments, from about 4% to about 10% of the cassava particles are held on a #120(US) sieve. In certain embodiments, from about 5% to about 10% of the cassava particles are held on a #120(US) sieve. In certain embodiments, from about 6% to about 10% of the cassava particles are held on a #120(US) sieve. In certain embodiments, from about 1% to about 9% of the cassava particles are held on a #120(US) sieve. In certain embodiments, from about 1% to about 8% of the cassava particles are held on a #120(US) sieve. In certain embodiments, from about 1% to about 7% of the cassava particles are held on a #120(US) sieve. In certain embodiments, from about 1% to about 6% of the cassava particles are held on a #120(US) sieve. In certain embodiments, from about 1% to about 5% of the cassava particles are held on a #120(US) sieve. In certain embodiments, from about 1% to about 4% of the cassava particles are held on a #120(US) sieve. In certain embodiments, from about 1% to about 3% of the cassava particles are held on a #120(US) sieve. In certain embodiments, from about :2% to about 9% of the cassava particles are held on a #120(US) sieve. In certain embodiments, from about 2% to about 8% of the cassava particles are held on a #120(US) sieve. In certain embodiments, from about 2% to about 7% of the cassava particles are held on a #120(US) sieve. In certain embodiments, from about 2% to about 6% of the cassava particles are held on a #120(US) sieve. In certain embodiments, from about 2% to about 5% of the cassava particles are held on a #120(US) sieve. In certain embodiments, from about 2% to about 4% of the cassava particles are held on a #120(US) sieve. In certain embodiments, from about 2% to about .3% of the cassava particles are held on a #120(US) sieve In certain embodiments, from about 3% to about 9% of the cassava particles are held on a #120(US) sieve. In certain embodiments, from about 3% to about 8% of the cassava particles are held on a #120(US) sieve. In certain embodiments, from about 3% to about 7% of the cassava particles are held on a #120(US) sieve. In certain embodiments, from about 3% to about 6% of the cassava particles are held on a #120(US) sieve. In certain embodiments, from about 3% to about 5% of the cassava particles are held on a #120(US) sieve. In certain embodiments, from about 3% to about 4% of the cassava particles are held on a #120(US) sieve. In certain embodiments, from about 4% to about 9% of the cassava particles are held on a #120(US) sieve. In certain embodiments, from about 4% to about 8% of the cassava particles are held on a #120(US) sieve. In certain embodiments, from about 4% to about 7% of the cassava particles are held on a #120(US) sieve. In certain embodiments, from about 4% to about 6% of the cassava particles are held on a #120(US) sieve. In certain embodiments, from about 4% to about 5% of the cassava particles are held on a #120(US) sieve. In certain embodiments, from about 5% to about 9% of the cassava particles are held on a #120(US) sieve. In certain embodiments, from about 5% to about 8% of the cassava particles are held on a #120(US) sieve. In certain embodiments, from about 5% to about 7% of the cassava particles are held on a #120(US) sieve. In certain embodiments, from about 5% to about 6% of the cassava particles are held on a #120(US) sieve. In certain embodiments, from about 6% to about 9% of the cassava particles are held on a #120(US) sieve. In certain embodiments, from about 6% to about 8% of the cassava particles are held on a #120(US) sieve. In certain embodiments, from about 6% to about 7% of the cassava particles are held on a #120(US) sieve. In certain embodiments, from about 7% to about 9% of the cassava particles are held on a #120(US) sieve. In certain embodiments, from about 7% to about 8% of the cassava particles are held on a #120(US) sieve. In certain embodiments, from about 8% to about 9% of the cassava particles are held on a #120(US) sieve.

Size distribution may also be determined with a #40(US) sieve, a #60(US) sieve, a #80(US) sieve, a #100(US) sieve, a #120(US) sieve, and a #140(US) sieve. ].n certain embodiments, less than about 10% of the cassava particles are held on a #140(US) sieve. In certain embodiments, from about 1% to about 10% of the cassava particles are held on a #140(US) sieve. In certain embodiments, from about 2% to about 10% of the cassava particles are held on a #140(US) sieve. In certain embodiments, from about 3% to about 10% of the cassava particles are held on a #140(US) sieve. In certain embodiments, from about 4% to about 10% of the cassava particles are held on a #140(US) sieve. In certain embodiments, from about 5% to about 10% of the cassava particles are held on a #140(US) sieve. In certain embodiments, from about 6% to about 10% of the cassava particles are held on a #140(US) sieve. In certain embodiments, from about 1% to about 9% of the cassava particles are held on a #140(US) sieve. In certain embodiments, from about 1% to about 8% of the cassava particles are held on a #140(US) sieve. In certain embodiments, from about 1% to about 7% of the cassava particles are held on a #140(US) sieve. In certain embodiments, from about 1% to about 6% of the cassava particles are held on a #140(US) sieve. In certain embodiments, from about 1% to about 5% of the cassava particles are held on a #140(US) sieve. In certain embodiments, from about 1% to about 4% of the cassava particles are held on a #140(US) sieve. In certain embodiments, from about 1% to about 3% of the cassava particles are held on a #140(US) sieve. In certain embodiments, from about 2% to about 9% of the cassava particles are held on a #140(US) sieve. In certain embodiments, from about 2% to about 8% of the cassava particles are held on a #140(US) sieve. In certain embodiments, from about 2% to about 7% of the cassava particles are held on a #140(US) sieve. In certain embodiments, from about 2% to about 6% of the cassava particles are held on a #140(US) sieve. In certain embodiments, from about 2% to about 5% of the cassava particles are held on a #140(US) sieve. In certain embodiments, from about 2% to about 4% of the cassava particles are held on a #140(US) sieve. In certain embodiments, from about 2% to about 3% of the cassava particles are held on a #140(US) sieve. In certain embodiments, from about 3% to about 9% of the cassava particles are held on a #140(US) sieve. In certain embodiments, from about 3% to about 8% of the cassava particles are held on a #140(US) sieve. In certain embodiments, from about 3% to about 7% of the cassava particles are held on a #140(US) sieve. In certain embodiments, from about 3% to about 6% of the cassava particles are held on a #140(US) sieve. In certain embodiments, from about 3% to about 5% of the cassava particles are held on a #140(US) sieve. In certain embodiments, from about 3% to about 4% of the cassava particles are held on a #140(US) sieve. In certain embodiments, from about 4% to about 9% of the cassava particles are held on a #140(US) sieve. In certain embodiments, from about 4% to about 8% of the cassava particles are held on a #140(US) sieve. In certain embodiments, from about 4% to about 7% of the cassava particles are held on a #140(US) sieve. In certain embodiments, from about 4% to about 6% of the cassava particles are held on a #140(US) sieve. In certain embodiments, from about 4% to about 5% of the cassava particles are held on a #140(US) sieve. In certain embodiments, from about 5% to about 9% of the cassava particles are held on a #140(US) sieve. In certain embodiments, from about 5% to about 8% of the cassava particles are held on a #140(US) sieve. In certain embodiments, from about 5% to about 7% of the cassava particles are held on a #140(US) sieve. In certain embodiments, from about 5% to about 6% of the cassava particles are held on a #140(US) sieve. In certain embodiments, from about 6% to about 9% of the cassava particles are held on a #140(US) sieve. In certain embodiments, from about 6% to about 8% of the cassava particles are held on a #140(US) sieve. In certain embodiments, from about 6% to about ‘7% of the cassava particles are held on a #140(US) sieve. In certain embodiments, from about 7% to about 9% of the cassava particles are held on a #140(US) sieve. In certain embodiments, from about 7% to about 8% of the cassava particles are held on a #140(US) sieve. In certain embodiments, from about 8% to about 9% of the cassava particles are held on a #140(US) sieve.

Size distribution can also be determined with a #40(US) sieve, a #60(US) sieve, a #80(US) sieve, a #100(US) sieve, a #120(US) sieve, a #140(US) sieve, and a #200(US) sieve. In certain embodiments, from about 2% to about 12% of the cassava particles are held on a #200(US) sieve. In certain embodiments, from about 4% to about 12% of the cassava particles are held on a #200(US) sieve. In certain embodiments, from about 6% to about 12% of the cassava particles are held on a #200(US) sieve. In certain embodiments, from about 8% to about 12% of the cassava particles are held on a #200(US) sieve. In certain embodiments, from about 10% to about 12% of the cassava particles are held on a #200(US) sieve. In certain embodiments, from about 2% to about 10% of the cassava particles are held on a #200(US) sieve. In certain embodiments, from about 2% to about 8% of the cassava particles are held on a #200(US) sieve. In certain embodiments, from about 2% to about 6% of the cassava particles are held on a #200(US) sieve. In certain embodiments, from about 2% to about 4% of the cassava particles are held on a #200(US) sieve. In certain embodiments, from about 4% to about 10% of the cassava particles are held on a #200(US) sieve. In certain embodiments, from about 4% to about 8% of the cassava particles are held on a #200(US) sieve. In certain embodiments, from about 4% to about 6% of the cassava particles are held on a #200(US) sieve. In certain embodiments, from about 6% to about 10% of the cassava particles are held on a #200(US) sieve. In certain embodiments, from about 6% to about 8% of the cassava particles are held on a #200(US) sieve.

Size distribution may also be determined with a #40(US) sieve, a #60(US) sieve, a #80(US) sieve, a #100(US) sieve, a #120(US) sieve, a #140(US) sieve, a #200(US) sieve, and a #400(US) sieve. In certain embodiments, from about 5% to about 25% of the cassava particles are held on a #400(US) sieve. In certain embodiments, from about 10% to about 25% of the cassava particles are held on a #400(US) sieve. In certain embodiments, from about 15% to about 25% of the cassava particles are held on a #400(US) sieve. In certain embodiments, from about 20% to about 25% of the cassava particles are held on a #400(US) sieve. In certain embodiments, from about 5% to about 20% of the cassava particles are held on a #400(US) sieve. In certain embodiments, from about 5% to about 15% of the cassava particles are held on a #400(US) sieve. In certain embodiments, from about 5% to about 10% of the cassava particles are held on a #400(US) sieve. In certain embodiments, from about 10% to about 20% of the cassava particles are held on a #400(US) sieve. In certain embodiments, from about 10% to about 15% of the cassava particles are held on a #400(US) sieve.

One of skill in the art will recognize that if the size distribution of a milled cassava product is determined without one or more screens, for example using a #40(US), #60(US), #80(US), #100(US), #140(US), #200(US), and #400(US) US sieves, but not a #120(US) sieve, the percentage of cassava particles held on the next finer screen than the screen that is omitted can be determined from the percentages provided herein by adding the percentage that would have been held on the omitted screen or screens to the percentage held on the next finer screen.

The size distribution of certain embodiments of a milled cassava product comprising milled cassava particles may also be described as determined with a #40(US) sieve, a #60(US) sieve, #80(US) sieve, and a #400(US) sieve. In certain embodiments, from about 15% to about 55% of the cassava particles are held on a #400(US) sieve. In certain embodiments, from about 20% to about 55% of the cassava particles are held on a #400(US) sieve. In certain embodiments, from about 25% to about 55% of the cassava particles are held on a #400(US) sieve. In certain embodiments, from about 30% to about 55% of the cassava particles are held on a #400(US) sieve. In certain embodiments, from about 40% to about 55% of the cassava particles are held on a #400(US) sieve. In certain embodiments, from about 45% to about 55% of the cassava particles are held on a #400(US) sieve. In certain embodiments, from about 50% to about 55% of the cassava particles are held on a #400(US) sieve. In certain embodiments, from about 15% to about 50% of the cassava particles are held on a #400(US) sieve. In certain embodiments, from about 15% to about 45% of the cassava particles are held on a #400(US) sieve. In certain embodiments, from about 15% to about 40% of the cassava particles are held on a #400(US) sieve. In certain embodiments, from about 15% to about 35% of the cassava particles are held on a #400(US) sieve. In certain embodiments, from about 15% to about 30% of the cassava particles are held on a #400(US) sieve. In certain embodiments, from about 15% to about 25% of the cassava particles are held on a #400(US) sieve. In certain embodiments, from about 15% to about 20% of the cassava particles are held on a #400(US) sieve. In certain embodiments, from about 20% to about 50% of the cassava particles are held on a #400(US) sieve. In certain embodiments, from about 20% to about 45% of the cassava. particles are held on a #400(US) sieve. In certain embodiments, from about 20% to about 40% the cassava particles are held on a #400(US) sieve. In certain embodiments, from about 20% to about 35% of the cassava particles are held on a #400(US) sieve. In certain embodiments, from about 20% to about 30% of the cassava particles are held on a #400(US) sieve. In certain embodiments, from about 20% to about 25% of the cassava particles are held on a #400(US) sieve. In certain embodiments, from about 25% to about 50% of the cassava particles are held on a #400(US) sieve. In certain embodiments, from about 25% to about 45% of the cassava particles are held on a #400(US) sieve. In certain embodiments, from about 25% to about 40% of the cassava particles are held on a #400(US) sieve. In certain embodiments, from about 25% to about 35% of the cassava particles are held on a #400(US) sieve. In certain embodiments, from about 25% to about 30% of the cassava particles are held on a #400(US) sieve. In certain embodiments, from about 30% to about 50% of the cassava particles are held on a #400(US) sieve. In certain embodiments, from about 30% to about 45% of the cassava particles are held on a #400(US) sieve. In certain embodiments, from about 30% to about 40% of the cassava particles are held on a #400(US) sieve. In certain embodiments, from about 30% to about 35% of the cassava particles are held on a #400(US) sieve. In certain embodiments, from about 35% to about 50% of the cassava particles are held on a #400(US) sieve. In certain embodiments, from about 35% to about 45% of the cassava particles are held on a #400(US) sieve. In certain embodiments, from about 35% to about 40% of the cassava particles are held on a #400(US) sieve. In certain embodiments, from about 40% to about 50% of the cassava particles are held on a #400(US) sieve. In certain embodiments, from about 40% to about 45% of the cassava particles are held on a #400(US) sieve. In certain embodiments, from about 45% to about 50% of the cassava particles are held on a #400(US) sieve.

Some percentage of the cassava particles may pass through all the screens. As used herein, such particles are referred to as being held or collected in the “pan.” The percentage of particles collected in the pan may be determined with a #40(US) sieve, a #60(US) sieve, a #80(US) sieve, a #100(US) sieve, a #120(US) sieve, a #140(US) sieve, a #200(US) sieve, and a #400(US) sieve. In certain embodiments, less than about 30% of the cassava particles are collected in the pan. In certain embodiments, less than about 25% of the cassava particles are collected in the pan. In certain embodiments, less than about 20% of the cassava particles are collected in the pan. In certain embodiments, less than about 15% of the cassava particles are collected in the pan. In certain embodiments, less than about 10% of the cassava particles are collected in the pan. In certain embodiments, less than about 5% of the cassava particles are collected in the pan. In certain embodiments, less than about 1% of the cassava particles are collected in the pan. In certain embodiments, from about 1% to about 30% of the cassava particles are collected in the pan. In certain embodiments, from about 5% to about 30% of the cassava particles are collected in the pan. In certain embodiments, from about 10% to about 30% of the cassava particles are collected in the pan. In certain embodiments, from about 15% to about 30% of the cassava particles are collected in the pan. In certain embodiments, from about 20% to about 30% of the cassava particles are collected in the pan. In certain embodiments, from about 25% to about 30% of the cassava particles are collected in the pan. In certain embodiments, from about 1% to about 25% of the cassava particles are collected in the pan. In certain embodiments, from about 1% to about 20% of the cassava particles are collected in the pan. In certain embodiments, from about 1% to about 15% of the cassava particles are collected in the pan. In certain embodiments, from about 1% to about 10% of the cassava particles are collected in the pan. In certain embodiments, from about 1% to about 5% of the cassava particles are collected in the pan. In certain embodiments, from about 5% to about 25% of the cassava particles are collected in the pan. In certain embodiments, from about 5% to about 20% of the cassava particles are collected in the pan. In certain embodiments, from about 5% to about 15% of the cassava particles are collected in the pan. In certain embodiments, from about 5% to about 10% of the cassava particles are collected in the pan. In certain embodiments, from about 10% to about 25% of the cassava particles are collected in the pan. In certain embodiments, from about 10% to about 20% of the cassava particles are collected in the pan. In certain embodiments, from about 10% to about 15% of the cassava particles are collected in the pan. In certain embodiments, from about 15% to about 25% of the cassava particles are collected in the pan. In certain embodiments, from about 15% to about 20% of the cassava particles are collected in the pan. In certain embodiments, from about 20% to about 25% of the cassava particles are collected in the pan.

V. Foodstuffs

The milled cassava product of the present invention can be used in various applications as an ingredient in foodstuffs. It is contemplated that the milled cassava product is suitable as a replacement for gluten-containing flours, particularly wheat flour, to replace a part or all of the flour used in certain foodstuffs. The milled cassava product is especially suitable as a replacement of a part or all of the gluten-containing flour in foodstuffs made from a batter or a dough. Representative examples of foodstuffs made from a batter include donuts, funnel cakes, pancakes, waffles, crepes, and batters for coating fried foods such as tempura, corndogs, onion rings, and fish. Representative examples of foodstuffs made from a dough include pie crust, pizza crust, crackers, tortillas, pasta, and other foodstuffs generally known as baked goods including cookies, pastries, cakes, muffins, biscuits, rolls, pretzels, and breads. Representative examples of other applications for flours in which the milled cassava product may substitute include streusel topping, crumb topping, roux or other sauce thickener, a coating for frying (e.g., fried chicken), nutritional bars, and breakfast cereals.

In addition to replacing some or all of the gluten-containing flour in foodstuffs, the milled cassava product is suitable for use in gluten-free foodstuffs to replace other gluten-free flours that are currently used. Whereas many gluten-free flours comprise blends of a number of types of flours from a variety of sources, the milled cassava product of the invention may be used as the only flour in a recipe, or to reduce the number of different types of flours, thus simplifying the preparation and cost of the foodstuff. The milled cassava product can also reduce or eliminate the need for alternatives approaches to reproducing the structure imparted by gluten, such as the use of eggs, starches, dairy products, gums and hydrocolloids, and other non-gluten proteins. As disclosed for foodstuffs comprising gluten-containing flours, the milled cassava product of the invention is suitable for use in a wide variety of gluten-free foodstuffs as a replacement of currently used gluten-free flours and flour blends.

Preparation of foodstuffs made with the milled cassava product of the invention can be done using well known methods of food preparation ranging from home cooking to industrial scale food preparation. In general, the milled cassava product of the invention can be substituted in for gluten-containing flours and gluten-free flours with little or no variation of existing recipes.

In certain embodiments, the milled cassava flour is used as the single flour to successfully make a foodstuff. Representative examples of foodstuffs wherein use of the milled cassava product as the single flour is especially suited include cookies, cakes, pancakes, and tortillas. In certain embodiments, other synergistic ingredients, including other flours, are used. For examples, to achieve certain properties such as a chewy texture, freeze/thaw tolerance, and/or extended shelf-life, additional synergistic ingredients such as additional flour, starch, gum, hydrocolloid, or combinations of such types are included. Other ingredients, such as sugar, salt, and yeast or other leavening agents (e.g., baking powder and baking soda) can be used in a fashion typical to standard baking recipes.

In certain embodiments, a foodstuff is made with a milled cassava product of the invention comprising a particle size distribution as described herein. In certain embodiments, the use of the milled cassava product results in a foodstuff that is a reduced gluten foodstuff. In certain embodiments, the use of the milled cassava product results in a gluten-free foodstuff. The milled cassava product of the invention may be used to replace a part or all of the gluten containing flour in certain recipes. Thus, in certain embodiments, a foodstuff comprising the milled cassava product of the invention does not contain wheat, rye, barley, oats, triticale, or kamut. In certain embodiments, a foodstuff does not contain wheat. The milled cassava product of the invention may be used to replace all or part of a gluten-free flour or blend of gluten-free flours in a recipe. Thus, in certain embodiments, a foodstuff comprising the milled cassava product of the invention does not contain rice, potato, maize, soy, or buckwheat. In certain embodiments, a foodstuff does not contain rice or potato.

### EXAMPLES

The following disclosed embodiments are merely representative of the invention which may be embodied in various forms. Thus, specific structural, functional, and procedural details disclosed in the following examples are not to be interpreted as limiting.

### Example 1

### Gluten-Free Chocolate Butter Cake

| | | |
|---|---|---|
| INGREDIENT | WEIGHT | PERCENTAGE |

| | | | |
|---|---|---|---|
| Milled cassava | 143.5 | grams | 16.19% |
| product | | | |
| Xanthan gum | 0.75 | grams | 0.085% |
| Baking soda | 0.5 | grams | 0.05% |
| Cocoa powder | 67 | grams | 7.55% |
| Unsalted butter | 108 | grams | 12.20% |
| Sucrose | 314 | grams | 35.41% |
| Egg yolks | 57 | grams | 6.48% |
| Egg whites | 86 | grams | 9.72% |
| Sour cream | 110 | grams | 12.31% |
| TOTAL | 886.75 | grams | 100% |

Method:

1. Blend the milled cassava product, cocoa powder, baking soda, and xanthan well. Set aside.

2. Cream the butter and 278 g of the sucrose very well until light.

3. Add the yolks one at a time.

4. Begin to make a meringue with the egg whites and remaining sucrose.

5. Add the sour cream to the base.

6. Blend the dry ingredients into the butter mixture.

7. Finish by folding the meringue into the base mixture.

Fill a 9 inch prepared cake pan 2/3 full and bake at 350 ° F. for 15 minutes. Reduce the heat to 325 ° F. and bake for approximately 20 to 25 minutes more until cake is done.

### Example 2

### Gluten-Free Chocolate Chip Cookies

Ingredients:

1 cup milled cassava product

½ stick butter, softened

¼ cup shortening

¾ cup brown sugar (packed)

1 tsp cream of tarter

½ tsp baking soda

½ tsp salt

½ tsp vanilla

1 egg

½ cup semisweet chocolate chips

Method:

Preheat oven to 350° F.

In a bowl sift milled cassava product, baking powder together.

In a separate bowl, add butter, shortening, brown sugar, and mix.

Add egg and mix.

Add vanilla and mix.

Slowly add flour mixture a little at a time and mix.

Drop dough on baking sheet.

Bake 9-11 minutes. Cool on tray for 2 minutes before moving to rack.

### Example 3

### Gluten Free Pancakes

Ingredients:

1 egg

¾ cup milled cassava product

1¼ cup milk

1 tsp baking powder

1½ TBSP sugar

2 TBSP vegetable oil

½ tsp salt

Method:

Preheat griddle to 375° F.

Mix egg, oil and milk.

In a separate bowl mix dry ingredients.

Add dry ingredients to liquids and stir.

Cook on griddle.

### Example 4

### Gluten-Free Peanut Butter Cookies

Ingredients:

½ cup granulated sugar

½ cup packed brown sugar

½ cup peanut butter

¼ cup shortening

¼ cup butter, softened

1 egg

1¼ cups of milled cassava product

¾ tsp baking soda

½ tsp baking powder

¼ tsp salt

Method:

Mix sugars, peanut butter, shortening, butter, and eggs in large bowl.

Stir in remaining ingredients.

Cover and refrigerate about 2 hours or until firm.

Heat oven to 375° F.

Shape dough into 1¼ inch balls. Place about 3 inches apart on ungreased cookie sheet.

Flatten in crisscross pattern with fork dipped into sugar.

Bake 9 to 10 minutes or until light golden brown.

Cool 5 minutes; remove from cookie sheet.

Cool on wire rack.

### Example 5

### Gluten-free Snickerdoodles

Ingredients:

1¼ cups milled cassava product

¼ cup shortening

¾ cup sugar

1 tsp cream of tartar

½ tsp baking soda

¼ tsp salt

1 egg

1 teaspoon vanilla

Method:

Preheat oven 350 ° F.

In a bowl sift milled cassava product, cream of tartar, salt, and baking powder together.

In a separate bowl, add shortening, sugar, and mix.

Add egg and mix.

Slowly add flour mixture a little at a time and mix.

Chill dough.

Roll into balls the size of walnuts.

Roll into a mixture of 1 tablespoon of sugar and 1/4 teaspoons of cinnamon.

Place about 2 inches apart on ungreased cookie sheet.

Bake 8 to 11 minutes.

Cool on tray for 2 minutes before moving to rack.

### Example 6

### Gluten-Free Oil-based Nigh Ratio Chocolate Cake

| | | |
|---|---|---|
| INGREDIENT | WEIGHT | PERCENTAGE |

| | | | |
|---|---|---|---|
| Milled cassava | 165 | grams | 12.0% |
| product | | | |
| Xanthan gum | 0.75 | grams | 0.055% |
| Baking soda | 9.5 | grams | 0.70% |
| Baking powder | 4.75 | grams | 0.35% |
| Cocoa powder | 76 | grams | 5.6% |
| Canola oil | 95 | grams (125 ml) | 7.0% |
| Sucrose | 400 | grams | 30.0% |
| Large eggs | 100 | grams | 7.4% |
| Whole milk | 250 | grams | 18.5% |
| Double strength | 250 | grams | 18.5% |
| brewed coffee | | | |
| TOTAL | 1,351 | grams | 100% |

Method:

Brew the coffee and allow to cool to room temperature. (An extract or compound could be used as well).

Combine the dry ingredients and sift.

Whip the eggs and sucrose and oil on medium speed until pale yellow in color and 3-4 time increased in volume. Approximately 6 to 8 minutes.

Add the dry ingredients and mix until well blended.

The milk/coffee needs to be added slowly at first in order to avoid the formation of lumps, scraping between additions.

As the batter gets thinner, the liquids can be added in larger increments. The batter will be very liquid.

Pour the batter into two prepared 9″ cake pans.

Bake at 350° F. for 20 minutes, then finish at 335° F. until the cakes tests done in the center, approximately 20 more minutes.

The cakes will be easier to remove if a cake liner is used in the cake pan.

### Example 7

### Gluten-Free White Butter Cake

| | | |
|---|---|---|
| INGREDIENT | WEIGHT | PERCENTAGE |

| | | | |
|---|---|---|---|
| Milled cassava | 150 | grams | 18.1% |
| product | | | |
| Xanthan gum | 0.75 | grams | 0.09% |
| Baking soda | 0.5 | grams | 0.06% |
| Unsalted butter | 113 | grams | 13.64% |
| Sucrose | 300 | grams | 36.2% |
| Egg yolks | 60 | grams | 7.24% |
| Egg whites | 90 | grams | 10.9% |
| Sour cream | 114 | grams | 13.76% |
| TOTAL | 828.25 | grams | 100% |

Method:

Blend the milled cassava product, xanthan, and baking soda well. Set aside.

Cream the butter and 250 g of the sucrose very well until light.

Add the yolks one at a time.

Begin to make a meringue with the egg whites and the remaining sucrose.

Add the sour cream to the base.

Fold the dry ingredients into the butter mixture.

Finish by folding the meringue into the base mixture.

Fill a 9 inch prepared cake pan ⅔ full and bake at 350° F. for 15 minutes.

Finish at 325 ° F. for approximately 20-25 more minutes.

### Example 8

### Size Distribution Data

Various samples of milled cassava products, representative of the mi [led cassava product of the invention were sized on a #40(US) sieve, #60(US) sieve, #80(US) sieve, #100(US) sieve, #120(US) sieve, #140(US) sieve, #200(US) sieve, and #400(US) sieve as described herein. The samples were also sized on a #40(US) sieve, 250 Micron screen (#60(US)), and 38 Micron screen (#400(US)). The size distribution of these representative examples is shown in Table 3.

TABLE 3
Size Distribution Data

| | Sample | Sample | Sample | Sample | Sample | Sample | Sample | Sample | Sample |
|---|---|---|---|---|---|---|---|---|---|
| % held on | 1 | 2 | 3 | 4 | 5 | 6 | 7 | 8 | 9 |
| #40(US) | 0.9 | 0.2 | 0.1 | 0.1 | 0.2 | 0.2 | 0.2 | 0.2 | 0 |
| #60(US) | 33.1 | 27.8 | 24.1 | 22.8 | 28 | 32.2 | 25.8 | 29.8 | 30.6 |
| #80(US) | 20.4 | 24.8 | 30.8 | 32.1 | 24.7 | 24.3 | 25.1 | 22.8 | 29.1 |
| #100(US) | 5.4 | 4.1 | 2.8 | 5 | 5.3 | 5 | 6.5 | 6 | 6.3 |
| #120(US) | 3.9 | 5.3 | 3.4 | 6.8 | 4.9 | 4.2 | 5.3 | 4.5 | 3.9 |
| #140(US) | 3.9 | 18.4 | 7.5 | 8.6 | 6.5 | 5 | 6.1 | 5.3 | 4.6 |
| #200(US) | 3.1 | 5 | 8.8 | 8.1 | 7.2 | 5.1 | 5.3 | 6 | 4.5 |
| #400(US) | 6.7 | 12.8 | 15.2 | 13.5 | 22.3 | 8.9 | 9.6 | 24.6 | 14.2 |
| Pan | 22.6 | 1.6 | 7.3 | 3 | 0.9 | 15.1 | 16.1 | 0.8 | 6.8 |
| #40(US) | 0.9 | 0.2 | 0.1 | 0.1 | 0.2 | 0.2 | 0.2 | 0.2 | 0 |
| 250 | 33.1 | 27.8 | 24.1 | 22.8 | 28 | 32.2 | 25.8 | 29.8 | 30.6 |
| Micron | | | | | | | | | |
| 38 | 43.4 | 70.4 | 68.5 | 74.1 | 70.9 | 52.5 | 57.9 | 69.2 | 62.6 |
| Micron | | | | | | | | | |
| Pan | 22.6 | 1.6 | 7.3 | 3 | 0.9 | 15.1 | 16.1 | 0.8 | 6.8 |

### Example 9

### Analytical Data

Various samples of milled cassava products, representative of the milled cassava product of the invention and corresponding to samples 1-9 in Example 8, were analyzed for a number of properties associated with food quality. This analytical data is shown in Table 3.

TABLE 4
Analytical Data

| | Sample | Sample | Sample | Sample | Sample | Sample | Sample | Sample | Sample |
|---|---|---|---|---|---|---|---|---|---|
| | 1 | 2 | 3 | 4 | 5 | 6 | 7 | 8 | 9 |
| Moisture | 10 | 5.37 | 5.21 | 4.09 | 5.81 | 5.27 | 5.37 | 5.69 | 6.05 |
| Protein | 1.75 | 0.9 | 0.7 | 1.1 | 0.9 | 0.8 | 1 | 0.9 | 0.9 |
| Fat | 0.5 | 0.479 | 0.542 | 0.579 | 0.62 | 0.502 | 0.578 | 5.13 | 5.85 |
| Dietary | | 7.68 | 7.1 | 7.94 | 7.78 | 7.38 | 7.98 | 7.52 | 7.68 |
| Fiber | | | | | | | | | |
| Ash | 1.02 | 0.514 | 0.62 | 0.606 | 0.665 | 0.654 | 0.889 | 0.668 | 0.738 |
| COOH | | 92.7 | | | 92 | 92.8 | | | |
| Calories | | 379 | 379 | 384 | 377 | 379 | 378 | 377 | 376 |
| TPC | 4800 | 4,000 | 5600 | 5400 | 9000 | 19000 | 11000 | 6800 | 60000 |
| Mold | 60 | 70 | 50 | 40 | 220 | 10 | 90 | 180 | 10 |
| Yeast | <10 | <10 | <10 | <10 | <10 | <10 | <10 | <10 | <10 |
| E. coli | <3 | <3 | <3 | <3 | <3 | <3 | <3 | <3 | <3 |
| Salmonella | Neg | Neg | Neg | Neg | Neg | Neg | Neg | Neg | Neg |
| Staph A | <10 | <10 | <10 | <10 | <10 | <10 | <10 | <10 | <10 |
| Cyanide | 0.31 | 0.39 | 0.26 | 0.42 | 0.72 | 0.39 | 0.41 | 0.33 | |
| Total Starch | 79.3 | 80.2 | 83.1 | 84.4 | 85.4 | 82.3 | 82.6 | 84.6 | 82.4 |
| Gelatinized | 29.7 | 37 | 31.4 | 26.7 | 37.6 | 33.9 | 33.2 | 40.8 | 38 |
| % | 37.5 | 46.1 | 37.7 | 31.7 | 44.1 | 41.2 | 40.3 | 48.2 | 46.1 |
| Gelatinized | | | | | | | | | |

What is claimed is:

1. A milled cassava product comprising particles of milled cassava, wherein the particle size distribution as determined by OCS Test 2839 (4^{th} edition) is:
less than about 1% of the particles are held on a #40(US) sieve when the size distribution is determined with a #40(US) sieve; and
(ii) from about 40% to about 65% of the particles are held on a #80(US) sieve when the size distribution is determined with a #40(US) sieve and a #80(US) sieve.

2. The milled cassava product of claim 1, wherein (iii) less than about 30% of the particles are collected on the pan when the size distribution is determined with a #40(US), #60(US), #80(US), #100(US), #120(US), #140(US), #200(US), and #400(US) sieve.

3. The milled cassava product of claim 2, wherein (iv) from about 20% to about 40% or the particles are held on a #60(US) sieve when the size distribution is determined with a #40(US), #60(US), and #80(US) sieve.

4. The milled cassava product of claim 3, wherein (v) from about 1% to about 10% of the particles are held on a #100(US) sieve when the size distribution is determined with a #40(US), #60(US), #80(US), and #100(US) sieve.

5. The milled cassava product of claim 4, wherein (vi) from about 1% to about 10% of the particles are held on a #120(US) sieve when the size distribution is determined with a #40(US), #60(US), #80(US), #100(US), and #120(US) sieve.

6. The milled cassava product of claim 5, wherein (vii) from about 1% to about 10% of the particles are held on a #140(US) sieve when the size distribution is determined with a #40(US), #60(US), #80(US), #100(US), #120(US), and a #140(US) sieve.

7. The milled cassava product of claim 6, wherein (viii) from about 2% to about 12% of the particles are held on a #200(US) sieve when the size distribution is determined with a #40(US), #60(US), #80(US), #100(US), #120(US), #140(US), and a #200(US) sieve.

8. The milled cassava product of claim 7 wherein (ix) from about 5% to about 25% of the particles are held on a #400(US) sieve when the size distribution is determined with a #40(US), #60(US), #80(US), #100(US), #120(US), #140(US), #200(US), and a #400(US) sieve.

9. A milled cassava product comprising particles of milled cassava, wherein the particle size distribution as determined by OCS Test 2839 (4^{th} edition) is:
(i) less than about 0.5% of the particles are held on a #40(US) sieve when the size distribution is determined with a #40(US) sieve; and
(ii) from about 50% to about 60% of the particles are held on a #80(US) sieve when the size distribution is determined with a #40(US) sieve and a #80(US) sieve.

10. The milled cassava product of claim 9, wherein (iii) from about 10% to about 25% of the particles are collected on the pan when the size distribution is determined with a #40(US), #60(US), #80(US), #100(US), #120(US), #140(US), #200(US), and #400(US) sieve.

11. The milled cassava product of claim 10, wherein (iv) from about 25% to about 35% or the particles are held on a #60(US) sieve when the size distribution is determined with a #40(US), #60(US), and #80(US) sieve.

12. The milled cassava product of claim 11, wherein (v) from about 4% to about 7% of the particles are held on a #100(US) sieve when the size distribution is determined with a #40(US), #60(US), #80(US), and #100(US) sieve.

13. The milled cassava product of claim 12, wherein (vi) from about 3% to about 5% of the particles are held on a #120(US) sieve when the size distribution is determined with a #40(US), #60(US), #80(US), #100(US), and #120(US) sieve.

14. The milled cassava product of claim 13, wherein (vii) from about 3% to about 7% of the particles are held on a #140(US) sieve when the size distribution is determined with a #40(US), #60(US), #80(US), #100(US), #120(US), and a #140(US) sieve.

15. The milled cassava product of claim 14, wherein (viii) from about 2% to about 6% of the particles are held on a #200(US) sieve when the size distribution is determined with a #40(US), #60(US), #80(US), #100(US), #120(US), #140(US), and a #200(US) sieve.

16. The milled cassava product of claim 15 wherein (ix) from about 6% to about 10% of the particles are held on a #400(US) sieve when the size distribution is determined with a #40(US), #60(US), #80(US), #100(US), #120(US), #140(US), #200(US), and a #400(US) sieve.

17. A foodstuff comprising a milled cassava product of claim 1.

18. The foodstuff of claim 17 wherein the foodstuff is a reduced gluten foodstuff.

19. The foodstuff of claim 17 wherein the foodstuff is a gluten-free foodstuff

20. The foodstuff of claim 17 wherein the foodstuff does not contain wheat, rye, barley, oats, triticale, or kamut.

21. The foodstuff of claim 20 wherein the foodstuff does not contain wheat.

22. The foodstuff of claim 17 wherein the foodstuff does not contain rice, potato, maize, soy, or buckwheat.

23. The foodstuff of claim 17 wherein the foodstuff is selected from the group consisting of donuts, funnel cakes, pancakes, waffles, crepes, and battered foods.

24. The foodstuff of claim 17 wherein the foodstuff is selected from the group consisting of pie crust, pizza crust, crackers, tortillas, and pasta.

25. The foodstuff of claim 17 wherein the foodstuff is a baked good.

26. The foodstuff of claim 25 wherein the foodstuff is selected from the group consisting of cookies, pastries, cakes, muffin, biscuits, rolls, pretzels, and bread.

27. A method of producing the milled cassava product of claim 1 comprising the steps of:
a) milling cassava into particles;
b) separating the milled particles by size;
c) blending the milled particles separated by size in proportions to produce the milled cassava product of claim 1.

28. A method of producing the milled cassava product of claim 1 comprising milling cassava into particles using processing equipment optimized to produce a milled product with a particle size distribution consistent with the milled cassava product of claim.
